(19) United States
(12) Patent Application Publication
(10) Pub. No.: US 2007/0236438 A1
(43) Pub. Date: Oct. 11, 2007

(54) Low power and high quality display device

(76) Inventor: Chih-Ta Star Sung, Glonn (DE)

Correspondence Address: Chih-Ta Star SUNG;RM. 308, BLD. 52, NO. 195, CHUNG HSING RD., SEC. 4, CHU TUNG TOWNSHIP, HSINCHU COUNTY, 310, TW

(21) Appl. No.: 11/401,490

(22) Filed: Apr. 11, 2006

(51) Int. Cl. G09G 3/36

(52) U.S. Cl. 345/88

(57) ABSTRACT

This invention applies a luminance detection device to determine the brightness of the place where the display device is located and adjusts the power of the light source accordingly. The photo sensor can also be place in front of the light source to detect the color deviation and to compensate the deviation by adding or subtracting the value of the corresponding color component which has color deviation. The image to be displayed is examined to determine the level of luminance and adjusts the power of the light source accordingly.

### BACKGROUND OF THE INVENTION

1. Field of Invention

The present invention relates to display device, and more particularly relates to the method and apparatus to reduce the power required for a display device and to compensate the color deviation of the light source.

2. Description of Related Art

In the past decades, the breakthrough of the optoelectronic technology, have driven the display system popular with top image quality. The display technology includes the LCD, Liquid Crystal Display, OLED. Organic Light Emitter Display, PDP, Plasma Display Panel, LCD Projectors. The prevailing advantage of enhanced image quality makes the derivative products popular in mass applications including LCD monitor, LCD/PDP TV, screen of note book computer, display screen of mobile phone (OLED or LCD), PDA, GPS, e-dictionary, . . . etc. The digital image and motion video have been adopted in an increasing number of applications, which include digital camera, scanner/printer/fax machine, video telephony, videoconferencing, surveillance system, VCD (Video CD), DVD, digital TV . . . etc. The success of development of the digital image and video compression standards fuels wider applications in digital display devices.

Taking the TFT, Thin Film Transistor LCD as an example, it uses liquid crystal to control the passage of light. The TFT-LCD panel may be thought of as two glass substrates sandwiching a layer of liquid crystal. The front glass substrate has a “coat” of a color filter, while the back glass has transistors fabricated on its surface. When voltage is applied to a transistor, the liquid crystal is crystallized and bent, allowing light to penetrate through to form a pixel. A light source locating at the back of the panel is called a “Back Light”. The front glass substrate is fitted with a color filter, which gives each pixel its own color. These pixels with each comprising in principle Red, Green and Blue color components form the image on the panel.

Some display devices like the projector uses a light source with high power to project the image out to a flat object to display the image through color filter in between the light source and the lens.

The light source is a device within the display system which consumes most power. The power consumption of a display device is dependent on the size of the display size. The larger the display the higher power is required. And, any light source will have more or less the color deviation. The longer a display is showing image, the higher degree of color deviation can be. Taking an LCD TV as an example, after turning on for several hours, the white light starts turning a little yellow which mixed with “Blue” can make pixels turn to “Green” this kind of color deviation degrades the image quality of display.

This invention of integrating a luminance detection to measure the brightness of the place where the display device is positioned and to adjust the power of the light source accordingly and to compensate the color deviation helps significantly reducing the power consumption of the display system and providing better image quality.

### SUMMARY OF THE INVENTION

The present invention is related to a method and apparatus of the image display device, which plays an important role in power reduction, specifically in the light source of the display device. The present invention significantly reduces the power consumption of the display system.
The present invention examines the luminance of an image to be displayed, if the picture has high degree of brightness, then, less power will be applied to the light source, if less brightness, the light source will be turned to brighter.
The present invention detects the degree of luminance of the place where the display device is positioned and adjusts the power of the light source of the display device.
According to an embodiment of the present invention, several photo sensor cells are used to detect color, said Red, Green and Blue of the projecting back/front light source, should deviation happens, then, information of the photo detector will be used to the display driver circuit to adjust the corresponding value to compensate the color deviation.
According to an embodiment of the present invention, for speeding up the performance, one Green component of every predetermined amount of pixels is selected to be examined to decide the brightness of an image to be displayed.
According to an embodiment of the present invention, should color deviation happens and color compensation is applied to adjust the color, the degree of deviation of each color component is added/subtracted to the value of the corresponding R,G and B color component in the display driver.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of block diagram of the display device.

FIG. 2 illustrates this invention of a display panel with automatic light source brightness adjustment.

FIG. 3 depicts the cross section of the light source and the basic display system.

FIG. 4 depicts the cross section of the principle of the image in a display system.

FIG. 5 depicts the block diagram of a cell of the display driver.

FIG. 6 illustrates the present invention of applying a luminance detector to adjust the brightness of the light source of the display system.

FIG. 7 illustrates the present invention of applying a luminance detector to detect the color deviation of the light source of the display system and to compensate in the display driver.

FIG. 8 illustrates the display system with the circuit of compensation in a display driver.

FIG. 9 depicts the means of brightness analysis of an image to be display in a display system.

### DESCRIPTION OF THE PREFERRED EMBODIMENTS

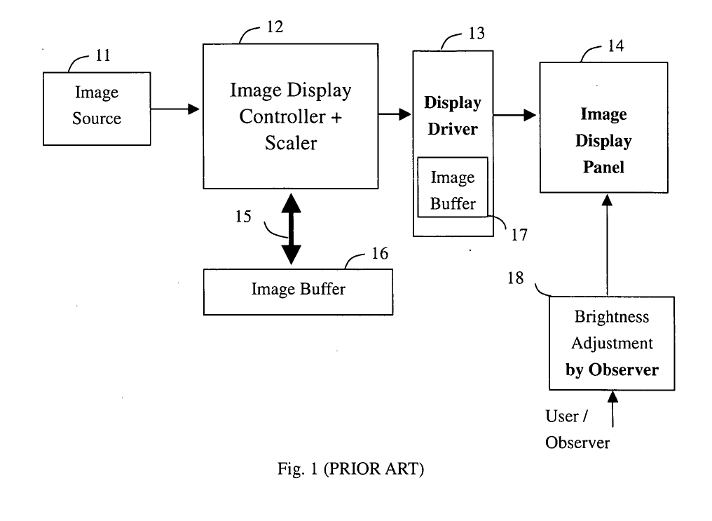

The quality of the display device has improved in the past decade coupled with the cost reduction has made the display device like the LCD, OLED and PDP display devices more popular. FIG. 1 illustrates the display devices which include an image source 11, a controller 12 and a display driver 13, a display panel 14 and in some devices, a user adjustable brightness controller 18. In some applications, the image to be displayed is temporarily stored in the frame buffer 16 for scaling or deinterlacing and the last image to be displayed is stored in a frame buffer 17 embedded in the display driver.

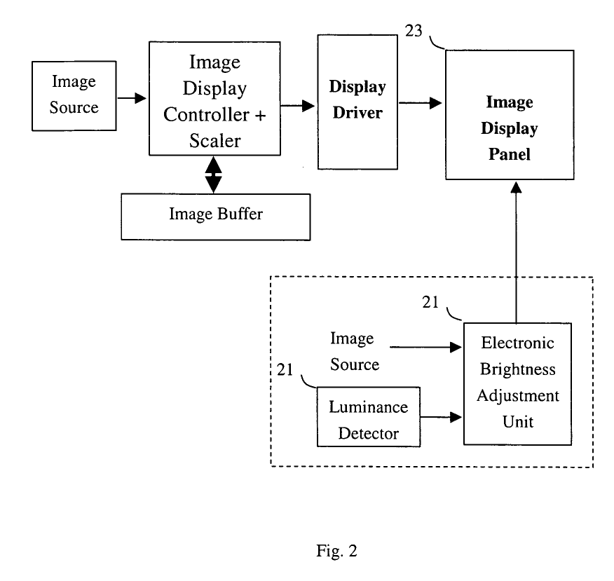

This invention as shown in FIG. 2 can significantly reduce the power consumption of a display device by implementing a luminance detector unit 21 which measures the brightness of the place where the display device is located. The level of brightness is sent to the electronic light source adjustment unit 22. When the brightness is higher, higher power of the light source will be applied to turn the light source brighter, while, When the brightness is lower, lower power of the light source will be applied to turn the light source less brighter. This mechanism reduces the power consumption when inside a building or in evening time. The light will penetrate through the display panel 23 to reach the observer.

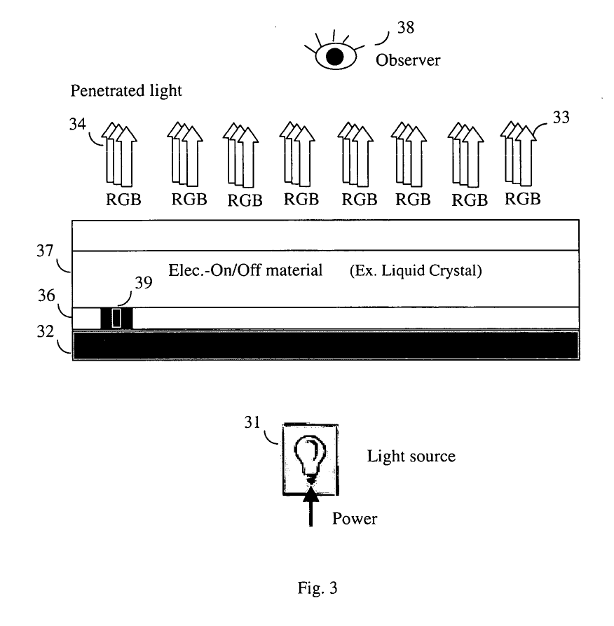

FIG. 3 depicts the principle of a display device which comprises a light source 31 and a display panel which includes a display driver 32 sticking to the panel and two transparent material with a layer of electrically On-Off material 37, for example the liquid crystal. A layer of color filter 36 with 3 color components Red, Green and Blue films 39 is placed between the light source and the display panel to let filtered colors with predetermined level of color to penetrate 33, 34 in the selected location which equivalent to 3 color components (R, G and B) and reach the observer 38.

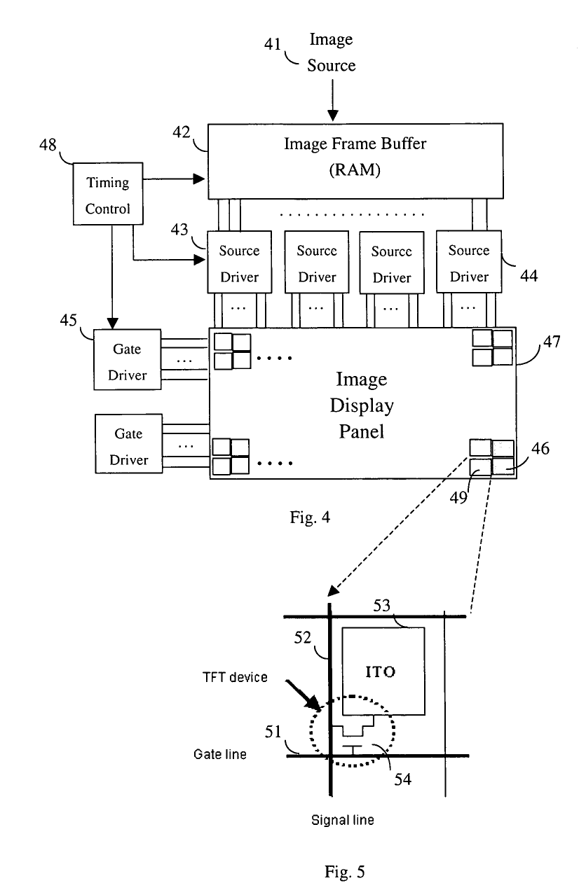

FIG. 4 depicts details of how the color filters coupled with the display driver work. An image source 41 to be displayed 42 is temporarily stored in an RAM 42 and driven out to be displayed controlled by a timing controller 48. The gate driver 45 functions as the row selector to determined which row (line) of image to be driven out The source driver 43, 44 drive out the color components with R, G and B colors each pixel of corresponding column by turning on the cells of the color filters of the corresponding locations. The color filters 46, 49 are coated on the display panel (ex. a layer of glass) by a thin film with 3 color components each pixel. FIG. 5 shows details of the color filter 53 and the driving circuitry which comprises of a selecting and driving transistor 54 (ex. TFT transistor), a transparent thin film with color 53, a selecting signal named “Gate Line” 51 and a signal source (or so named “Source Line” 52). The gate line turns on the transistor, and the source line provides corresponding strength of color of signal which is converted from the image data from the image buffer RAM.

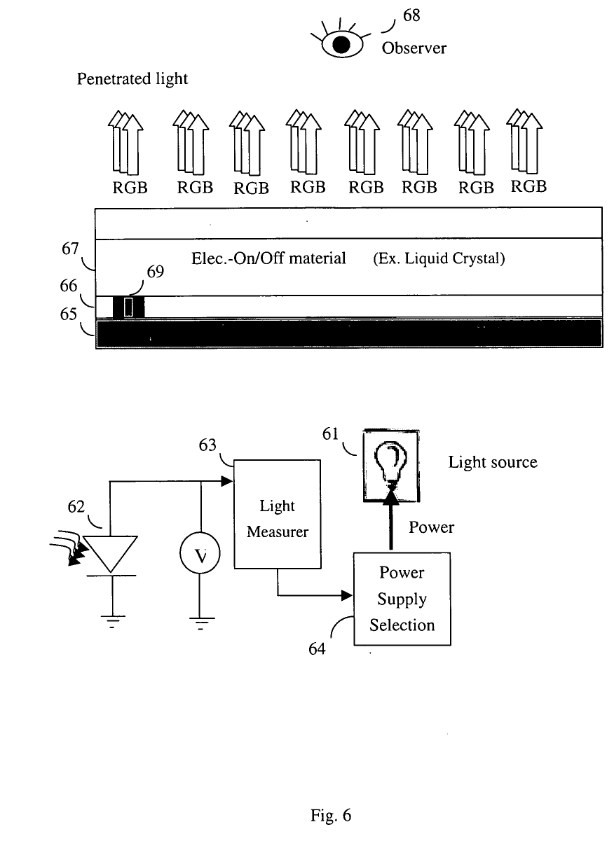

FIG. 6 illustrates details of this invention of deploying a luminance detection unit, for instance, a photo detector diode 62 with a voltage meter to measure the degree 63 of the charge trapped in the photo diode. The luminance detector is to measure the brightness of the place where the display device is located. The measured information of the luminance is used to determine the power of the light source 61. The stronger the luminance, the strong the light power would be needed to show good image quality, the weaker the luminance, the less light power would be needed. Therefore, the luminance detector information is used to adjust 62 the power of the light source. A layer of color filter 66 with 3 color components, Red, Green and Blue films 69 is placed between the light source and the display panel to let filtered colors with predetermined level of color (done by a driver 65) to penetrate in the selected location which equivalent to 3 color components (R, G and B) and reach the observer 68.

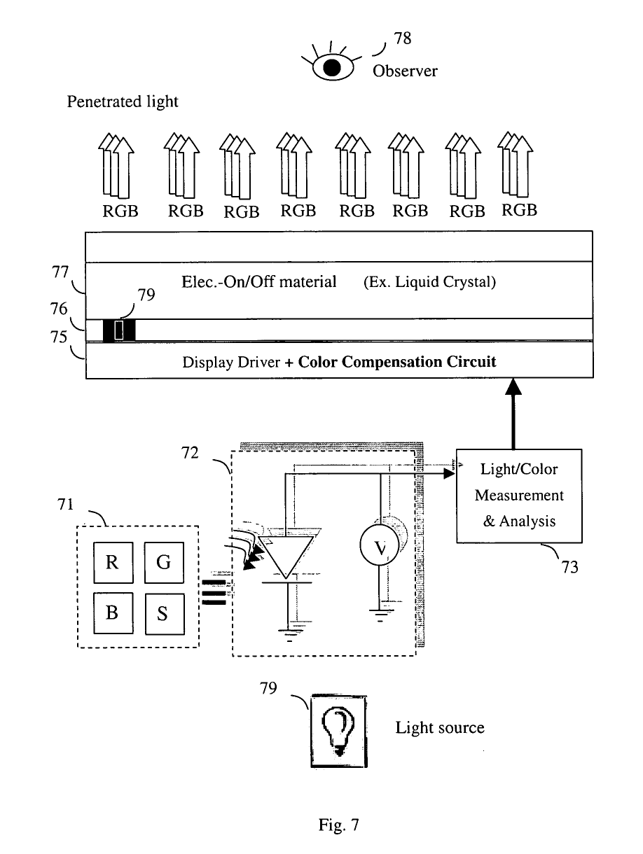

To achieve higher image quality in displaying, another mechanism of this invention is shown in FIG. 7. A color detection device comprising of 3 photo diodes with Red, Green and Blue color filter on top of them is deployed to detect the 3 color components 71 of the light source. The detected color deviation information of any of the 3 color components are measured and analyzed 73 and connected to the display driver for color compensation 75 for the corresponding color component which has color deviation. A redundant photo diode is deployed for replacing the defect photo diode of the 3 diodes with no color filter on top. Should one of the 3 photo diodes is bad, a corresponding color filter will be put on top of the redundant photo diode to form a new replacement. This color compensation circuitry can detect the color deviation and compensate it and hence provides better image quality in display.

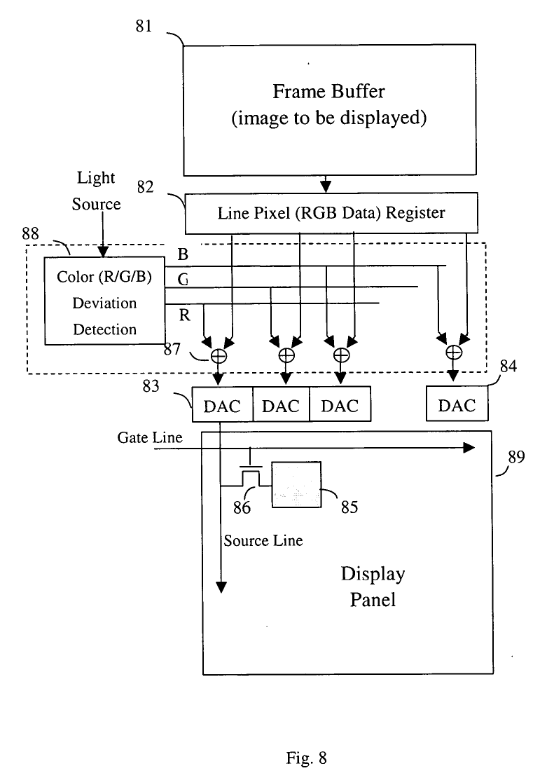

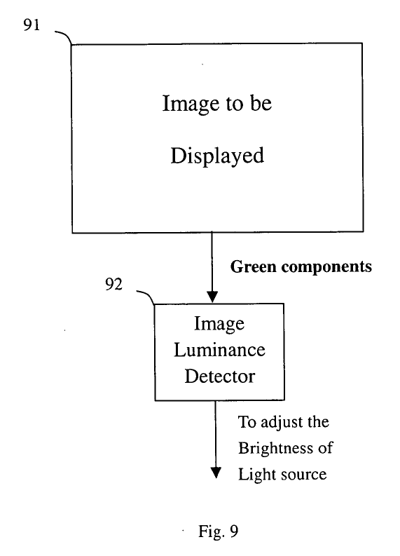

FIG. 8 depicts how the color deviation detection and compensation circuitry works with the display driver. An image frame to be displayed is stored in a frame buffer 81 and shifted line by line 82 to a register before the digitized color information is converted into analog signals. The color deviation detection 88 circuitry provides the analyzed color information of Red, Green and Blue to the driver circuitry to be added (or subtracted) to/from the digitized pixel data and converted into analog voltage through the DAC, Digital-2-Analog Converter 83, 84 before driving out to the so called source line 866 which is conducted through a selecting transistor to turn the color filter 85 which is a thin film coated on to the display panel. When no color deviation happens, the deviation information can be set to all “0” and the driver provides normal voltage from the DAC. Should the color is deviated, the value of compensation wil be added or subtracted to be combined with the image data.

For further enhancing the image quality in displaying and reducing power consumption, an image luminance examination mechanism is applied to check the brightness of an image to be displayed 91. Should the image has most pixels with less brightness, the power of the light source can be turned higher to let the observer see low brightness. Should the image has most pixels with high brightness, the power of the light source can be turned lower. For speeding up the process of examining the image brightness, only one of every predetermined amount of Green components within an image is accumulated to the sum of Green color components since Green dominates most degree of the brightness of an image.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. An apparatus of displaying image, comprising:
a display panel with color filters on it selecting the corresponding color components to penetrate from the light source to observer;
a driver device to convert the digitized image information into voltage level and to be conducted to the corresponding location within a transparent electric conducting;
a device to detect the luminance of the place where the display device is located; and
a light source with adjustable power supplier level controller by the information imported from the photo detection unit, when the luminance level is lower, the power of the light source will be reduced, while the luminance level is higher, the power of the light source will be increased;

2. The apparatus of claim 1, wherein the light source is put in the back side of the observer with color filters of Red, Green and Blue colors in front of it to allow each pixel having three color components to penetrate.

3. The apparatus of claim 1, wherein the display panel is formed by at least two layers of glassed with liquid crystal sandwiched between the two glassed layers.

4. The apparatus of claim 1, wherein the plasma is formed by at least two layers of glassed with liquid crystal sandwiched between the two glassed layers.

5. The apparatus of claim 1, wherein the display driver is placed on to the back glass which has a transparent electrical film fitted on it.

6. The apparatus of claim 1, wherein a photo detection circuit is formed by a photo diode to detect the luminance by measuring the voltage of the surface of the diode and to be connected to control the power supplier of the light source.

7. The apparatus of claim 1, wherein the light source has switch which selects the power supply with the level determined by the luminance detection circuit.

8. An apparatus of continuously displaying image, comprising:
a display panel with color filters on it selecting the corresponding color components to be penetrated from the light source to observer;
a driver device to convert the digitized image format into voltage level and to be conducted to a transparent electric conducting film of the corresponding location of a display panel;
a photo detection unit to examine the color deviation of the light source; and
a color compensation unit which imports the information of the color deviation from the photo detection unit and compensates the color deviation by adding or subtracting the value of the corresponding color component which has color deviation.

9. The apparatus of claim 8, wherein the photo detection device is comprised of at least one photo diode for detecting the Red color, one photo diode for detecting the Green color and one photo diode for detecting the Blue color.

10. The apparatus of claim 8, wherein the photo detection device has one redundant photo diode to replace the defect of the three photo diodes.

11. The apparatus of claim 8, wherein when the color deviation happens, the detected color which as deviation will be compensated by adding or subtracting value from the corresponding color of the display driver.

12. The apparatus of claim 8, wherein the voltage value of the DAC is shifted by adding or subtracting the compensation value should the color deviation happens in a corresponding color component.

13. The apparatus of claim 8, wherein the color components are Red, Green and Blue colors.

14. A method of display image, comprising
receiving at least one image to be displayed;
examining the brightness of the image to be displayed on to a display device; and
adjusting the power supplier level of the light source by the information of the brightness of the image to be displayed, wherein if the brightness level is lower, the power of the light source will be increased, while the brightness level is higher, the power of the light source will be reduced;

15. The method of claim 14, wherein the green color component is used to detect the brightness of the image to be displayed.

16. The method of claim 14, wherein one of every predetermined amount of green color components is selected to be examined for the luminance detection.

17. The method of claim 14, wherein the sum of the accumulative value of the selected green color components is examined to decide the level of luminance of the image to be displayed.
